(19) United States
(12) Patent Application Publication
(10) Pub. No.: US 2012/0285787 A1
(43) Pub. Date: Nov. 15, 2012

(54) BILL DEPOSITING AND DISPENSING DEVICE

(75) Inventors: Kazuhiro HOSOKAWA, Gunma (JP); Yukihiro NEMOTO, Gunma (JP); Katsuyoshi TOMIZAWA, Gunma (JP); Koukichi SHIMADA, Gunma (JP)

(73) Assignee: OKI ELECTRIC INDUSTRY CO., LTD., Tokyo (JP)

(21) Appl. No.: 13/452,807

(22) Filed: Apr. 20, 2012

(30) Foreign Application Priority Data
May 11, 2011 (JP) 2011-105910

(51) Int. Cl. G07F 7/04; G07D 7/00

(52) U.S. Cl. 194/206

(57) ABSTRACT

A bill depositing-and-dispensing device has: a customer-interface unit including a customer-interface-opening for performing a transaction of a bill with a user, a conveying-path connecting the customer-interface-opening and a storage-destination of a bill, a switching mechanism switching a traveling-path of a bill in accordance with a storage-destination of a bill conveyed on the conveying-path, and a discriminating section discriminating a bill conveyed on the conveying-path; at least one storage-cassette including a storage portion storing a bill, a first conveying-path connecting to the customer-interface unit or an adjacent storage-cassette, a second conveying-path conveying a bill in both directions between the first conveying-path and the storage portion, a switching mechanism switching a traveling-path of a bill, and a thickness sensor identifying a thickness of a bill drawn-out from the storage portion; and a reject take-in unit storing a bill that is not held at the customer-interface unit and the storage-cassette.

### CROSS-REFERENCE TO RELATED APPLICATION

This application claims priority under 35 USC 119 from Japanese Patent Application No. 2011-105910 filed May 11, 2011, the disclosure of which is incorporated by reference herein.

### BACKGROUND OF THE INVENTION

1. Field of the Invention

The present invention relates to a bill depositing and dispensing device, and, in further detail, relates to the unit structure of a bill depositing and dispensing device.

2. Related Art

As shown in FIG. 14 for example, a bill depositing and dispensing device 10 that is used in banking operations or the like is structured from plural units. The conventional bill depositing and dispensing device 10 shown in FIG. 14 is formed from a customer interface unit 1, a discriminating section unit 2, a temporary holding section unit 3, storage cassettes 4 (4a through 4d), a rejected medium storage cassette 5, a left-behind medium storage cassette 6, and plural conveying units (7a through 7e) that connect these units and cassettes.

The customer interface unit 1 is a unit that receives a deposit of bills (banknotes) from a user and dispenses bills to a user. The customer interface unit 1 conveys the deposited bills via the conveying unit 7a to the discriminating section unit 2 or the temporary holding section unit 3. When a deposited bill is conveyed via the conveying unit 7a to the discriminating section unit 2, and is further conveyed to the temporary holding section unit 3, the bill is conveyed via the conveying units 7c, 7d, 7b. Further, switching mechanisms 8 for switching the destination of conveying of a bill are provided at the respective conveying units 7.

The discriminating section unit 2 is a unit that carries out judgment of the legitimate/counterfeit nature, the undamaged (normal)/damaged state (damage characteristics), the denomination (kind), and the obverse/reverse sides of a bill. A bill that is judged to be a legitimate bill by the discriminating section unit 2 is conveyed via the conveying units 7c, 7d to the storage cassette 4. Further, when a bill that is judged to be a legitimate bill is conveyed to the temporary holding section unit 3, the bill is conveyed via the conveying units 7a, 7b to the temporary holding section unit 3. Moreover, at the time of dispensing bills in accordance with a user's request, the discriminating section unit 2 carries out discrimination of a bill, that has been stored in the storage cassette 4, before the bill is conveyed to the bill transaction opening of the customer interface unit 1, and conveys a bill, that is judged to be normal as a result of this discrimination, to the customer interface unit 1 via the conveying units 7a, 7b.

The temporary holding section unit 3 is a unit that temporarily stores a bill that is conveyed-in via the conveying unit 7a. The storage cassettes 4 are storage sections that store bills, and the four storage cassettes 4a through 4d are provided in the bill depositing and dispensing device 10 shown in FIG. 14. By adjusting the destination of conveying of a bill at the switching mechanism 8 of the conveying unit 7d in accordance with the type of the bill that has been conveyed-in, bills can be classified and stored in the respective storage cassettes 4a through 4d. By providing the plural storage cassettes 4 in this way, the reserving and recovery of bills can be carried out easily per type.

The rejected medium storage cassette 5 stores bills that are judged to be abnormal by the discriminating section unit 2. The discriminating section unit 2 conveys a bill, that is judged to be abnormal, to the rejected medium storage cassette 5 via the conveying units 7a, 7b, 7e or the conveying units 7c, 7d, 7e. The left-behind medium storage cassette 6 stores bills that a user has forgotten to take-out from the bill transaction opening of the client interface unit 1. If a bill in the bill transaction opening is not taken-out within a predetermined time, the customer interface unit 1 conveys that bill via the conveying units 7a, 7c, 7d, 7e to the left-behind medium storage cassette 6.

In this way, the conventional bill depositing and dispensing device 10 is structured by connecting and combining, by conveying units, units that have been collected together per function. For example, Japanese Patent Application Laid-Open (JP-A) No. 2001-236542 discloses a bill depositing and dispensing device in which storage cassettes can be added in the form of a vertical (longitudinal) line behind a bill processing section as vertical (longitudinal) position.

However, at the conventional bill depositing and dispensing device 10 shown in FIG. 14, there is a large number of units that structure the device and the conveying path is long. Therefore, the number of parts, such as conveying motors, conveying rollers, drive transmission parts, conveying guides, travel sensors, and the like becomes large, and the device becomes expensive. Further, because there are many units, there are many places at which the work of opening/closing a unit and the work of clearing-up a jam are needed, and there is the problem that the ease of operation is poor. Moreover, because the conveying path is long and the number of parts that structure the conveying units is large, there is also the problem that sounds generated from the device are loud and become noise.

Still further, in consideration of the work of opening/closing the units and the ease of the operation of loading/removing the cassettes, the units at the upper portion and the units at the upper portion must be pulled-out separately. Rail members and lock mechanism members must be provided respectively thereat, and the number of parts that structure the device becomes large. Moreover, if the substrate that controls the operations of the units at the upper portion and the substrate that controls the operations of the units at the lower portion are provided separately, cords that connect the substrates and cord guiding members are needed. Further, in consideration of the pulling-out of the units, the cord lengths are long, and accompanying this, the number of cord guiding members also becomes large, and there is the problem that the device becomes expensive.

### SUMMARY OF THE INVENTION

Thus, the present invention was developed in view of the above-described problems, and an object thereof is to provide a novel and improved bill depositing and dispensing device in which the conveying path of bills can be shortened.

In order to achieve the above-described object, in accordance with a certain standpoint of the present invention, there is provided a bill depositing and dispensing device that has: a customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, and a discriminating section that discriminates a bill that is conveyed on the conveying path; at least one storage cassette that includes a storage portion that stores a bill, a first conveying path that connects to the customer interface unit or an adjacent storage cassette, a second conveying path that conveys a bill in both directions between the first conveying path and the storage portion, a switching mechanism that switches a traveling path of a bill, and a thickness sensor that identifies a thickness of a bill that is drawn-out from the storage portion; and a reject take-in unit that stores a bill that is not held at the customer interface unit and the storage cassette.

In accordance with the present invention, processings that are required of the device can be carried out by few structural units. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized.

Here, it is possible that the switching mechanism of the customer interface unit has: a first switching mechanism that bifurcates a drawn-out conveying path of a bill that is drawn-out from the customer interface opening and a drawn-into conveying path of a bill that is drawn-into the customer interface opening, the conveying path including the drawn-out conveying path and the drawn-into conveying path; a second switching mechanism that switches the conveying path such that an abnormal bill, at which an abnormality is detected by the discriminating section of the customer interface unit or the thickness sensor of the storage cassette, is conveyed to a first depository of the reject take-in unit; and a third switching mechanism that switches the conveying path such that a bill, that has been left behind at the customer interface opening, is conveyed to a second depository of the reject take-in unit.

Further, it is possible that the discriminating section of the customer interface unit is structured by a plurality of sensors for judging a legitimate/counterfeit nature of a bill and for identifying overlapped-feeding of bills that are conveyed on the conveying path, and the plurality of sensors that structure the discriminating section are disposed such that, the longer the time required for data processing by a sensor, the nearer to the customer interface opening the sensor is located.

Moreover, it is possible that the customer interface unit and the storage cassette are disposed so as to be adjacent to one another in a horizontal direction.

Further, in order to achieve the above-described object, in accordance with another standpoint of the present invention, there is provided a bill depositing and dispensing device that has: a customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, a discriminating section that discriminates a bill that is conveyed on the conveying path, and a thickness sensor that identifies a thickness of a bill that is drawn-out to the customer interface opening; at least one storage cassette that includes a storage portion that stores a bill, a first conveying path that connects to the customer interface unit or an adjacent storage cassette, a second conveying path that conveys a bill in both directions between the first conveying path and the storage portion, and a switching mechanism that switches a traveling path of a bill; and a reject take-in unit that stores a bill that is not held at the customer interface unit and the storage cassette.

It is possible that the bill depositing and dispensing device includes a plurality of storage cassettes, and at at least one of the storage cassettes, the switching mechanism thereof is a switching mechanism that can switch traveling of a bill in three directions.

Moreover, in order to achieve the above-described object, in accordance with another standpoint of the present invention, there is provided a bill depositing and dispensing device that has: customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, and a discriminating section that discriminates a bill that is conveyed on the conveying path; at least one storage cassette that includes a storage portion that stores a bill, and a storage cassette conveying path that conveys a bill in both directions to and from the storage portion; a conveying unit that includes a conveying unit conveying path that connects between the customer interface unit and the storage cassette, a switching mechanism that switches a traveling path of a bill in accordance with a storage destination of the bill that is conveyed on the conveying unit conveying path, and a thickness sensor that identifies a thickness of a bill that is drawn-out from the storage cassette; and a reject take-in unit that stores a bill that is not held at the customer interface unit and the storage cassette.

In a case of plural storage cassettes, the conveying unit conveying path connects between the customer interface unit and the respective storage cassettes, and plural switching mechanisms are provided.

It is possible that the conveying unit conveying path of the conveying unit and a drawn-into conveying path of a bill, that is drawn-into the customer interface opening, of the conveying path of the customer interface unit are driven by a same driving device.

Further, in order to achieve the above-described object, in accordance with another standpoint of the present invention, there is provided a bill depositing and dispensing device that has: a customer interface unit that includes a customer interface opening for carrying out a transaction of a bill with a user, and a conveying path that connects an adjacent unit and the customer interface opening; a discriminating/conveying unit as the adjacent unit, which includes a discriminating/conveying unit conveying path that connects the customer interface unit and a storage destination of a bill, a switching mechanism that switches a traveling path of a bill in accordance with a storage destination of a bill that is conveyed on the discriminating/conveying unit conveying path, and a discriminating section that discriminates a bill that is conveyed on the discriminating/conveying unit conveying path; at least one storage cassette that includes a storage portion that stores a bill, and a storage cassette conveying path that conveys a bill in both directions to and from the storage portion; a conveying unit that includes a conveying unit conveying path that connects between the discriminating/conveying unit and the storage cassette, a switching mechanism that switches a traveling path of a bill in accordance with a storage destination of the bill that is conveyed on the conveying unit conveying path, and a thickness sensor that identifies a thickness of a bill that is drawn-out from the storage cassette; and a reject take-in unit that stores a bill that is not held at the customer interface unit and the storage cassette.

In a case of plural storage cassettes, the conveying unit conveying path connects between the customer interface unit and the respective storage cassettes, and plural switching mechanisms are provided.

It is possible that the bill depositing and dispensing device includes a plurality of storage cassettes, and the conveying unit includes a plurality of switching mechanisms, and at least one of the switching mechanisms of the conveying unit is a switching mechanism that can switch traveling of a bill in three directions.

As described above, in accordance with the present invention, there can be provided a bill depositing and dispensing device in which the conveying path of bills can be shortened.

### BRIEF DESCRIPTION OF THE DRAWINGS

Embodiments of the invention will be described in detail with reference to the following figures, wherein:

FIG. 1 is a schematic structural drawing showing a bill depositing and dispensing device relating to a first exemplary embodiment of the present invention;

FIG. 2 is an explanatory drawing showing the flow of a bill at the time of depositing processing of the bill depositing and dispensing device relating to the first exemplary embodiment;

FIG. 3 is an explanatory drawing showing the flow of a bill at the time of deposit return processing of the bill depositing and dispensing device relating to the first exemplary embodiment;

FIG. 4 is an explanatory drawing showing the flow of a bill at the time of dispensing processing of the bill depositing and dispensing device relating to the first exemplary embodiment;

FIG. 5 is an explanatory drawing showing the flow of a bill at the time of taking-in processing of a dispensed bill that has been left behind, of the bill depositing and dispensing device relating to the first exemplary embodiment;

FIG. 6 is a schematic structural drawing showing the structure of a bill depositing and dispensing device relating to a second exemplary embodiment of the present invention;

FIG. 7 is a schematic structural drawing showing the structure of a bill depositing and dispensing device relating to a third exemplary embodiment of the present invention;

FIG. 8 is an explanatory drawing showing motor driving ranges of the bill depositing and dispensing device relating to the third exemplary embodiment;

FIG. 9 is a schematic structural drawing showing the structure of a bill depositing and dispensing device relating to a fourth exemplary embodiment of the present invention;

FIG. 10 is a schematic structural drawing showing the structure of a bill depositing and dispensing device relating to a fifth exemplary embodiment of the present invention;

FIG. 11 is an explanatory drawing showing the flow of a bill at the time of depositing processing of the bill depositing and dispensing device relating to the fifth exemplary embodiment;

FIG. 12 is an explanatory drawing showing the flow of a bill at the time of deposit return processing of the bill depositing and dispensing device relating to the fifth exemplary embodiment;

FIG. 13 is an explanatory drawing showing the flow of a bill at the time of storing processing of the bill depositing and dispensing device relating to the fifth exemplary embodiment; and

FIG. 14 is a schematic structural drawing showing a structural example of a conventional bill depositing and dispensing device.

### DETAILED DESCRIPTION OF THE INVENTION

Exemplary embodiments of the present invention are described in detail hereinafter with reference to the appended drawings. Note that, in the present specification and drawings, structural elements having substantially the same functional structures are denoted by the same reference numerals such that redundant description is omitted.

### 1. First Exemplary Embodiment

### [Structure of Bill Depositing and Dispensing Device]

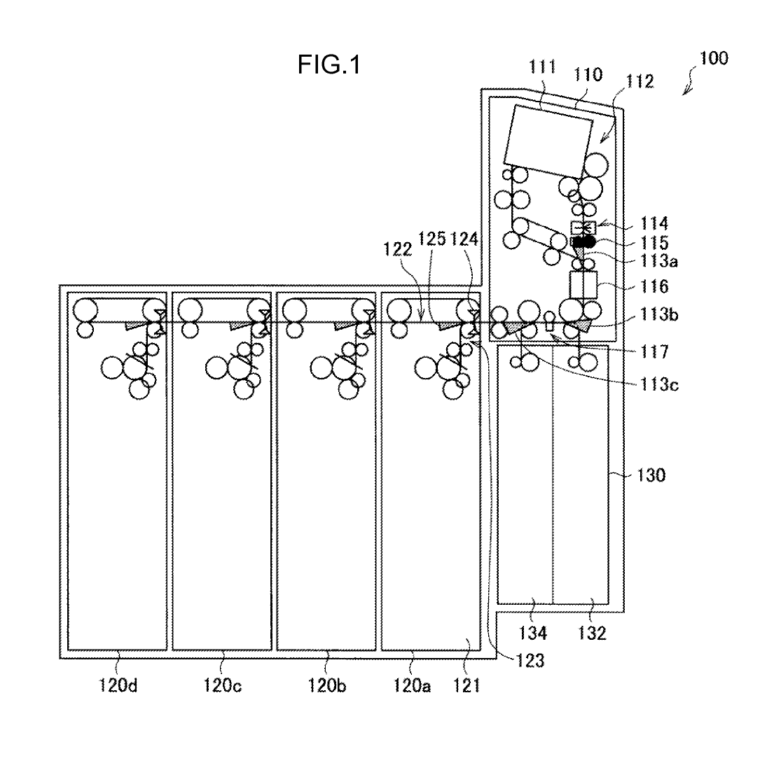

First, the schematic structure of a bill depositing and dispensing device relating to a first exemplary embodiment of the present invention is described with reference to FIG. 1. Note that FIG. 1 is a schematic structural drawing showing the structure of a bill depositing and dispensing device 100 relating to the present exemplary embodiment.

As shown in FIG. 1, the bill depositing and dispensing device 100 relating to the present exemplary embodiment is formed from a customer interface unit (reception unit) 110, storage cassettes 120 (120a through 120d), and a reject take-in unit 130.

The customer interface unit 110 is a unit that carries out receiving of and transfer of (handing) bills (banknotes) from and to users. As shown in FIG. 1, the customer interface unit 110 has a customer interface opening 111 having a draw-out mechanism that draws (feeds) out deposited bills, and an accumulating mechanism that accumulates dispensed bills. The customer interface opening 111 and the storage cassettes 120 and the reject take-in unit 130 (destination of conveying, that is, storage destinations) are connected by a conveying path 112. Switching mechanisms 113a, 113b, 113c for switching the destination of conveying of a bill are provided on the conveying path 112. Further, a transmission-type image sensor 114, a thickness sensor 115, a reflection-type image sensor 116 and a magnetic sensor 117, that are for identifying the denomination (kind), the legitimate/counterfeit nature, the thickness and the like of a bill, are provided on the conveying path 112. The transmission-type image sensor 114, the thickness sensor 115, the reflection-type image sensor 116 and the magnetic sensor 117 collectively are also called a discriminating section.

As shown in FIG. 1, the conveying path 112 of the customer interface unit 110 has a conveying path of a bill that is drawn-out from a bill draw-out opening of the customer interface opening 111, and a conveying path of a bill that is drawn-in into the bill draw-out opening of the customer interface opening 111. By the first switching mechanism 113a that is provided on the conveying path 112 of the customer interface unit 110, these conveying paths are forked apart (bifurcated) at the customer interface opening 111 side and merge together at the storage cassette 120 side. The second switching mechanism 113b and the third switching mechanism 113c are provided on the conveying path 112 of the customer interface unit 110, from the first switching mechanism 113a toward the storage cassette 120 side. The second switching mechanism 113b switches the conveying path 112 such that an abnormal bill, at which an abnormality is sensed by the discriminating section of the customer interface unit 110 or a thickness sensor (reference numeral 124) of the storage cassette 120 that is described later, is conveyed to a rejected medium depository 132 of the reject take-in unit 130. The third switching mechanism 113c switches the conveying path 112 such that a bill, that has been left-behind at the customer interface opening 111, is conveyed to a left-behind medium depository 134 of the reject take-in unit 130.

Because the traveling path of a bill can be switched by these switching mechanism 113a through 113c, the degrees of freedom in the placement of the respective sensors that are provided on the conveying path 112 and the conveying path 112 increase.

Further, the discriminating section of the customer interface unit is structured (formed) from the transmission-type image sensor 114, the thickness sensor 115, the reflection-type image sensor 116 and the magnetic sensor 117, that are disposed on the conveying path 112 from the customer interface opening 111 toward the storage cassettes 120. The transmission-type image sensor 114 carries out legitimate/counterfeit judgment processing of a bill. The thickness sensor 115 identifies overlapped-feeding of bills. The reflection-type image sensor 116 carries out, for example, number checking of a bill, and can manage actual articles in accordance with these results of detection. Note that, although the discriminating section relating to the present exemplary embodiment is structured from these four sensors, the present invention is not limited to this example, and can be changed appropriately in accordance with the discriminating processings. With regard to these respective sensors that structure the discriminating section, the longer the time that a sensor requires for data processing, the closer that sensor is disposed toward the customer interface opening 111 side. In the present exemplary embodiment, the transmission-type image sensor 114, that is used in judging the legitimate/counterfeit nature of a bill, is disposed furthest toward the customer interface opening 111 side. This is in order to be able to devise shortening (optimization) of the conveying path for the device on the whole, because data is acquired in order from data of a higher priority, and this processing can be completed before the processing for judging the forking of the path of a bill (the switching of the conveying path of a bill).

To describe in further detail, the transmission-type image sensor 114 and the thickness sensor 115 are disposed between the customer interface opening 111 and the first switching mechanism 113a (i.e., on the conveying path of a bill that is drawn-out from the customer interface opening 111). Accordingly, at times of dispensing bills or the like, a bill that is drawn-in into the customer interface opening 111 is not identified by the transmission-type image sensor 114 and the thickness sensor 115, but because the legitimate/counterfeit judging processing of a bill has already been carried at the conveying path of the bills that are drawn-out from the customer interface opening 111, identification by these sensors is unnecessary. Further, the reflection-type image sensor 116 is provided between the first switching mechanism 113a and the second switching mechanism 113b. Moreover, the magnetic sensor 117 is provided between the second switching mechanism 113b and the third switching mechanism 113c.

By placing the respective sensors on the conveying path 112 in this way, a bill can be led to a predetermined conveying path at the point in time when the bill passes the sensor which is necessary in accordance with the conveying processing. Due thereto, the conveying path 112 can be shortened and simplified.

In this way, because the customer interface unit 110 relating to the present exemplary embodiment has the function of discriminating bills, there is no need to separately provide a discriminating section unit as is the case conventionally. Due thereto, the number of units that structure the device can be reduced, and the conveying path also can be shortened.

The storage cassette 120 has a storage portion 121 that stores bills, a first conveying path 122 that makes possible the transfer of bills in both directions between the customer interface unit 110 and/or the storage cassettes 120 positioned front side and rear side (positioned adjacently) (that is, the first conveying path 122 of the storage cassette 120a connects (the conveying path 112 of) the customer interface unit 110 and (the first conveying path of) the storage cassette 120b which is adjacent, the first conveying path of the storage cassette 120b connects (the first conveying path of) the adjacent storage cassette 120c and (the first conveying path of) the adjacent storage cassette 120a, and the first conveying path of the storage cassette 120d connects to (the first conveying path of) the adjacent storage cassette 120c), and a second conveying path 123 having a draw-out mechanism that draws-out a bill from the storage portion 121 and an accumulating mechanism that accumulates bills into the storage portion 121. Further, the storage cassette 120 has the thickness sensor 124 that identifies the thickness of bills that are deposited and dispensed, and a switching mechanism 125 for switching the destination of conveying of a bill. The four storage cassettes 120a through 120d are provided in the bill depositing and dispensing device 100 relating to the present exemplary embodiment, in a state of being lined-up in the horizontal direction, and the respective storage cassettes 120a through 120d are structured the same. Here, the thickness sensor 124 may be structured by a sensor that is the same as a travel sensor that detects the conveyed state (overlapped-feeding, chain-feeding, approaching, skewing or the like) of a bill, or by another different sensor. These sensors are structured by a sensor part such as an optical sensor, an ultrasonic sensor, a magnetic sensor, or the like, or by a combination of such sensor part and a thickness detecting mechanism such as rollers or the like.

Note that the number of the storage cassettes 120 that are provided at the bill depositing and dispensing device 100 is not limited to this example, and, for example, the storage cassettes 120 can be provided in accordance with the number of types of bills. Further, at at least one of the storage cassettes 120a through 120d, the switching mechanism 125 of that storage cassette 120 may be a switching mechanism that can switch the traveling of a bill in three directions.

The reject take-in unit 130 has the rejected medium depository 132 that stores bills that are identified as being fed in an overlapping manner due to an abnormality in the drawing-out at the time of the dispensing processing, and the left-behind medium depository 134 that stores bills that users have forgotten to take. Rejected bills and bills that are left-behind are stored in the reject take-in unit 130 by switching by the switching mechanisms 113b and 113c of the customer interface unit 110.

As shown in FIG. 1, in the bill depositing and dispensing device 100 relating to the present exemplary embodiment, for example, the reject take-in unit 130 is disposed beneath the customer interface unit 110, and the storage cassette 120a is disposed such that the lower portion side of one side surface of the customer interface unit 110 and the upper portion side of one side surface of the storage cassette 120a face one another. The storage cassettes 120a through 120d are disposed adjacent to one another in the horizontal direction as described above. By arranging the customer interface unit 110, the storage cassettes 120a through 120d and the reject take-in unit 130 in this way, bills that are sensed to be abnormal in the process of conveying the bills within the customer interface unit 110, and bills that users have left behind, can be conveyed to the reject take-in unit 130, and only bills that can be stored in the storage cassettes 120 can be conveyed to the storage cassettes 120. Further, by connecting the first conveying paths 122 of the respective cassettes at the upper portion sides of the respective storage cassettes 120a through 120d, a bill that is being conveyed can be conveyed to and stored in the corresponding storage cassette 120, without providing a separate conveying unit.

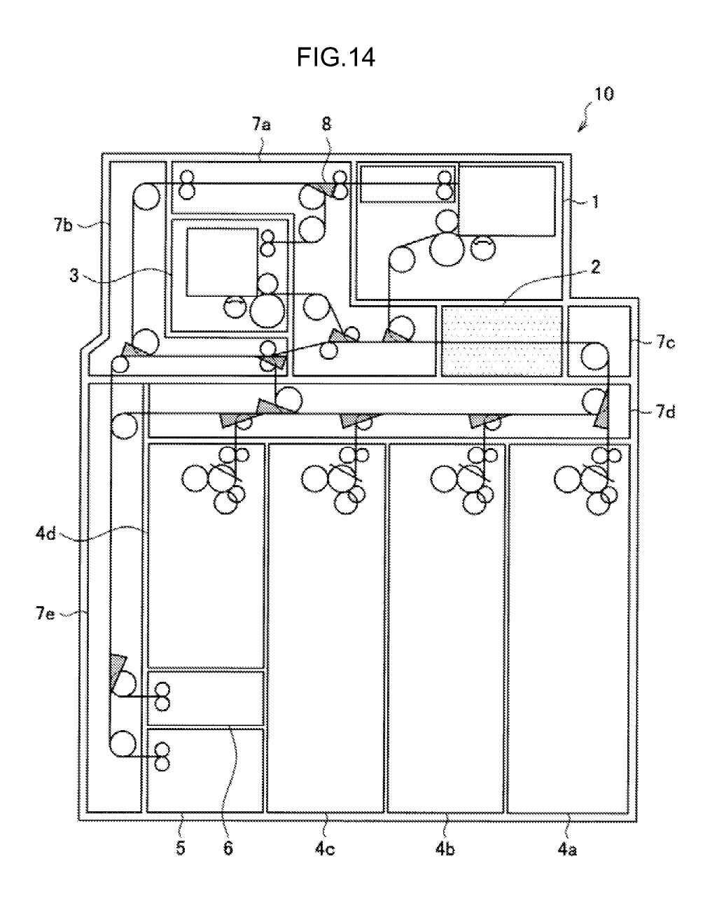

Further, the temporary holding section unit 3, that is set at the conventional bill depositing and dispensing device 10 shown in FIG. 14 for example, is not provided at the bill depositing and dispensing device 100 relating to the present exemplary embodiment. Therefore, the device can be structured by fewer units.

Moreover, the sensors 114 through 117, that are provided at the customer interface unit 110 and are for identifying the denomination, legitimate/counterfeit nature, thickness and the like of a bill, and the sensors 124, that are provided at the respective storage cassettes 120a through 120d and are for identifying the thickness of a bill, are provided separately at the bill depositing and dispensing device 100 relating to the present exemplary embodiment. Due thereto, in the conveying path on which a bill is made to travel during the identification processing, the switching mechanisms 113b, 113c, 125, can be operated and switched on the basis of the results of judgment of the discriminating processing, so, the needed conveying path length can be shortened.

### [Operation of Bill Depositing and Dispensing Device]

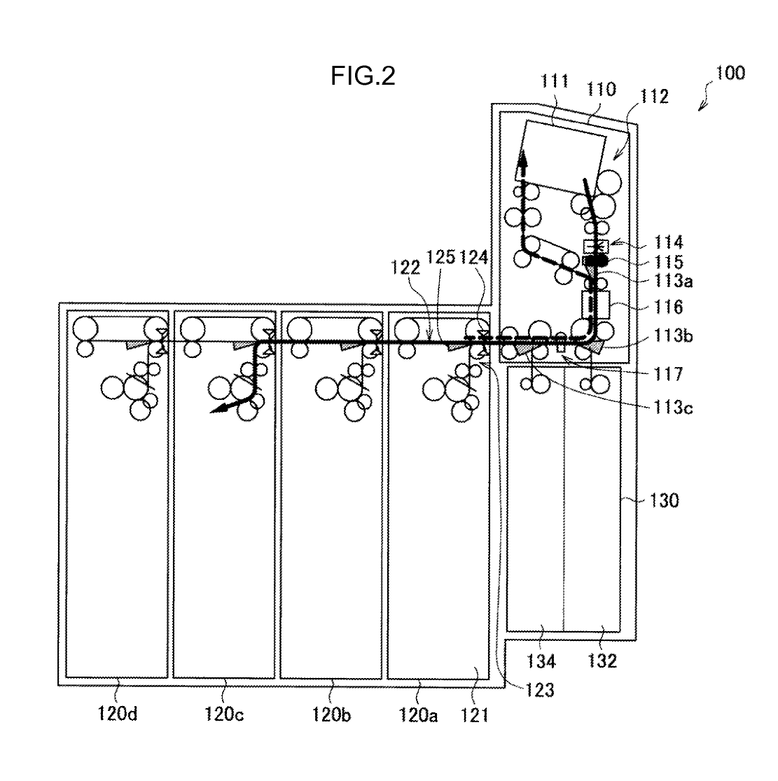

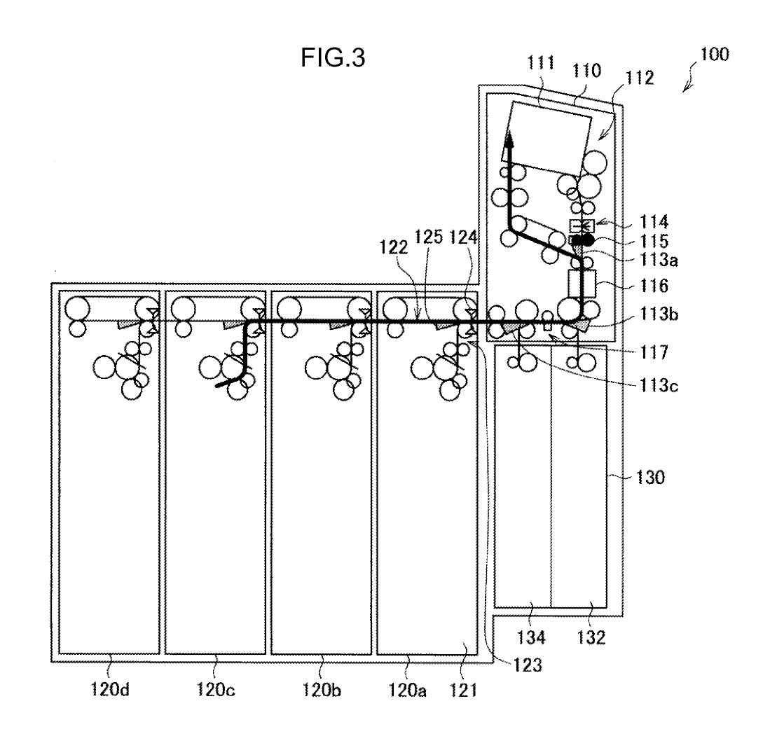

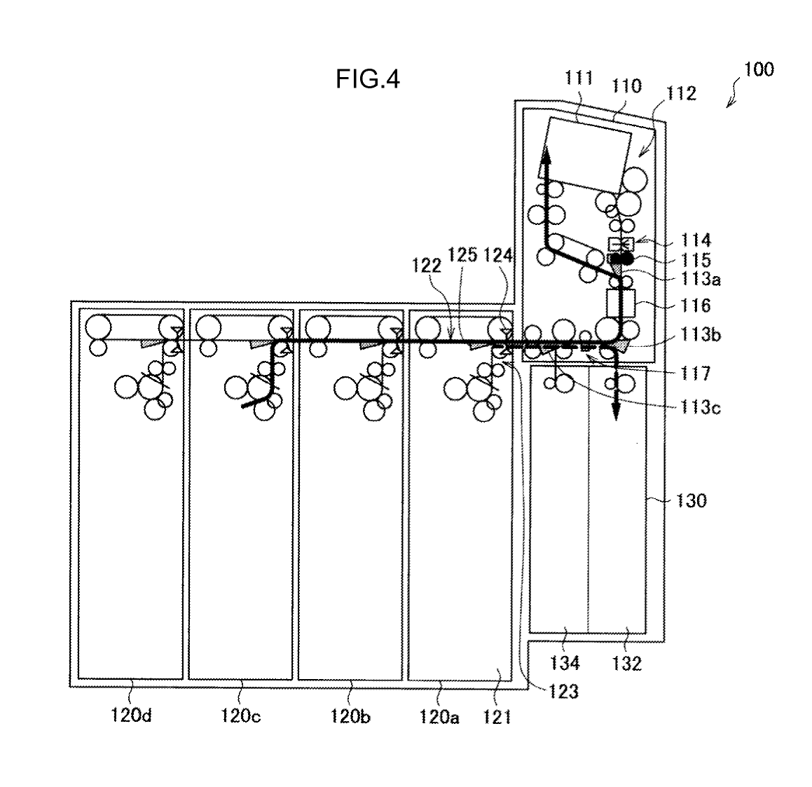

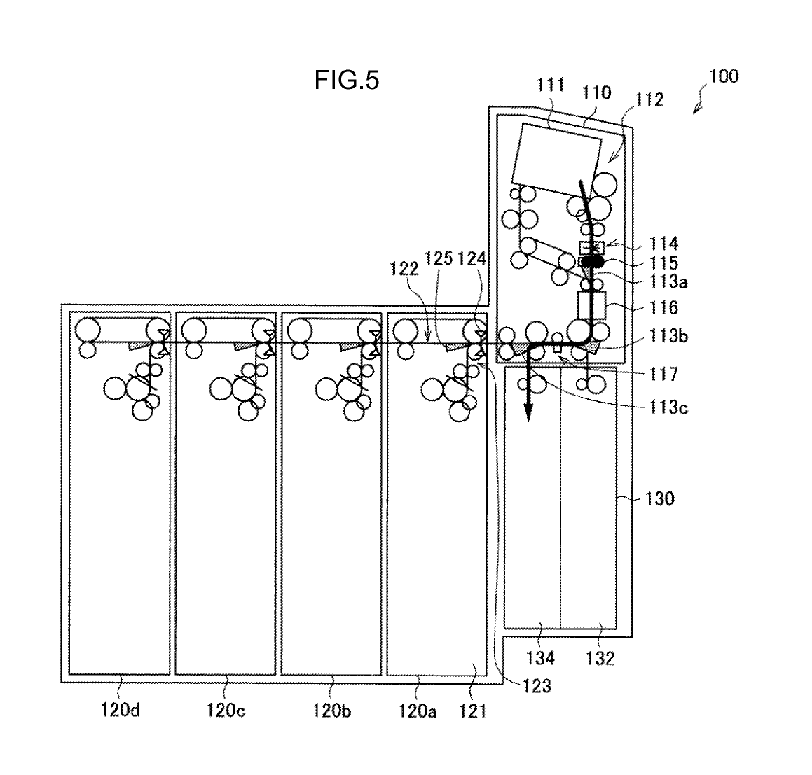

Next, the operation of the bill depositing and dispensing device 100 relating to the present exemplary embodiment is described on the basis of FIG. 2 through FIG. 5. Note that FIG. 2 is an explanatory drawing showing the flow of a bill at the time of depositing processing of the bill depositing and dispensing device 100 relating to the present exemplary embodiment. FIG. 3 is an explanatory drawing showing the flow of a bill at the time of deposit return processing of the bill depositing and dispensing device 100 relating to the present exemplary embodiment. FIG. 4 is an explanatory drawing showing the flow of a bill at the time of dispensing processing of the bill depositing and dispensing device 100 relating to the present exemplary embodiment. FIG. 5 is an explanatory drawing showing the flow of a bill at the time of taking-in processing of a dispensed bill that has been left behind, of the bill depositing and dispensing device 100 relating to the present exemplary embodiment.

(1) At the Time of Depositing Processing

First, the operation of the bill depositing and dispensing device 100 at the time of depositing processing is described on the basis of FIG. 2. A bill that is deposited from the customer interface opening 111 of the customer interface unit 110 is conveyed along the path shown by the solid line arrow in FIG. 2. Namely, at the bill depositing and dispensing device 100, a bill that has been inserted (entered) into the customer interface opening 111 is discriminated by the transmission-type image sensor 114, the thickness sensor 115, the reflection-type image sensor 116 and the magnetic sensor 117 that are within the client interface unit 110 and are provided on the conveying path, and the denomination is discerned (judged) on the basis of the results of detection of the respective sensors. Then, the bill depositing and dispensing device 100 operates the switching mechanisms 125 of the respective storage cassettes 120 such that that bill is stored in the storage cassette 120 that corresponds to the discerned denomination. For example, the solid line arrow shown in FIG. 2 shows the path by which a bill, that is deposited in from the customer interface opening 111, is stored in the storage cassette 120c.

On the other hand, when a bill that has been inserted into the customer interface opening 111 is identified as a counterfeit bill or a damaged bill in accordance with the results of detection by the transmission-type image sensor 114, the thickness sensor 115, the reflection-type image sensor 116 and the magnetic sensor 117 that are within the client interface unit 110 and are provided on the conveying path, the bill depositing and dispensing device 100 stops the driving of the motor (not shown in the drawings) that drives the conveying mechanism of the conveying path. Then, due to the bill depositing and dispensing device 100 switching the switching mechanism 113a and reversely rotating the motor that drives the conveying mechanism, the bill that has been identified as a counterfeit bill or a damaged bill is conveyed to the customer interface opening 111 by the path shown by the dashed line arrow in FIG. 2. This bill that is returned to the customer interface opening 111 is accumulated at the final end of the bills that remain without being drawn-out within the customer interface opening 111.

Thereafter, the depositing processing is restarted by the motor again being driven in the direction of drawing-out bills, and a bill, that remains in the customer interface opening 111 without being drawn-out, and a bill, that is identified as a counterfeit bill or a damaged bill, are again drawn-out from the customer interface opening 111. Then, in a case in which there is a bill, that is identified as a counterfeit bill or a damaged bill even when the depositing processing is carried out a predetermined number of times and that is returned to the customer interface opening 111 without being conveyed to the storage cassettes 120, the bill depositing and dispensing device 100 opens the shutter (not shown in the drawings) of the customer interface opening 111 and returns that bill to the user. At this time, by providing the path shown by the dashed line arrow in FIG. 2, a bill that is identified as a counterfeit bill or a damaged bill can be accumulated at the final end of the bills that remain without being drawn-out within the customer interface opening 111. Accordingly, it is possible to return to the user only a bill that is identified as a counterfeit bill or a damaged bill.

(2) At the time of Deposit Return Processing

Next, operation of the bill depositing and dispensing device 100 at the time of deposit return processing is described on the basis of FIG. 3. When a bill that a user has inserted into the customer interface opening 111 is conveyed along the path shown by the solid line arrow in FIG. 2 and is stored in a storage cassette 120, and thereafter, the depositing processing is cancelled, the bill depositing and dispensing device 100 draws the deposited bill out from the storage cassette 120 (the storage cassette 120c in FIG. 3), and conveys the bill along the path shown by the solid line arrow in FIG. 3 and feeds the bill into the customer interface opening 111. Then, the bill depositing and dispensing device 100 opens the shutter (not shown in the drawings) of the customer interface opening 111 and returns that bill to the user.
(3) At the time of Dispensing Processing
Operation of the bill depositing and dispensing device 100 at the time of dispensing processing is described on the basis of FIG. 4. When the bill depositing and dispensing device 100 receives a dispense instruction from a user, the bill depositing and dispensing device 100 draws-out the necessary bill from the respective storage cassettes 120 (the storage cassette 120c in FIG. 4), and conveys the bill along the path of the solid line arrow shown in FIG. 4 and feeds the bill into the customer interface opening 111. At this time, the bill depositing and dispensing device 100 identifies the thickness of the drawn-out bill by the thickness sensor 124 of the storage cassette 120 from which the bill is drawn-out. If, as a result thereof, overlapped-feeding is detected, as shown by the dashed line arrow in FIG. 4, the bill depositing and dispensing device 100 switches the switching mechanism 113b within the customer interface unit 110, and feeds the bills into the rejected medium depository 132. In this way, by identifying the thickness of the bill also at the time of the dispensing processing, bills can be prevented from being conveyed to the customer interface opening 111 with being fed in an overlapping manner.
(4) At the Time of Processing of Taking-In a Dispensed Bill that has been Left Behind
Lastly, the operation of the bill depositing and dispensing device 100 at the time of the processing of taking-in a dispensed bill that has been left behind is described on the basis of FIG. 5. When a predetermined time passes in a state in which a user has left behind a bill that was dispensed into the customer interface opening 111, the bill depositing and dispensing device 100 draws the bill out again from the customer interface opening 111, and conveys the bill within the customer interface unit 110 on the path of the solid line arrow shown in FIG. 5, and feeds the bill into the left-behind medium depository 134 by the switching mechanism 113c that has been switched.

In this way, in accordance with the bill depositing and dispensing device 100 relating to the present exemplary embodiment, processings required of the device can be carried out by few structural units. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized. Further, by reducing the number of units, there are fewer places at which the work of opening/closing a unit and the work of clearing-up a jam are needed, and the ease of operation also can be improved. Moreover, by shortening the conveying path length, sounds generated from the device also can be reduced.

Further, by arranging the respective units such that no unit exists above the storage cassettes 120, not only does the ease of the operation of loading/removing the storage cassettes 120 improve, but also, there is no need to separately pull out units at an upper portion and units at a lower portion, and the need to respectively provide rail members and lock mechanism members also is eliminated. Moreover, in a case in which a substrate that controls the operation of units at an upper portion and a substrate that controls the operation of units at a lower portion are provided separately, the substrates can be made integral. Therefore, electronic parts having redundant functions, cords that connect the substrates, and cord guide members can be eliminated, and thus, the structure of the device can be simplified, and an inexpensive device can be realized. There is also the advantage that, when adding storage cassettes in accordance with the demands of the user, such a situation can be handled by making slight changes.

### 2. Second Exemplary Embodiment

### [Structure of Bill Depositing and Dispensing Device]

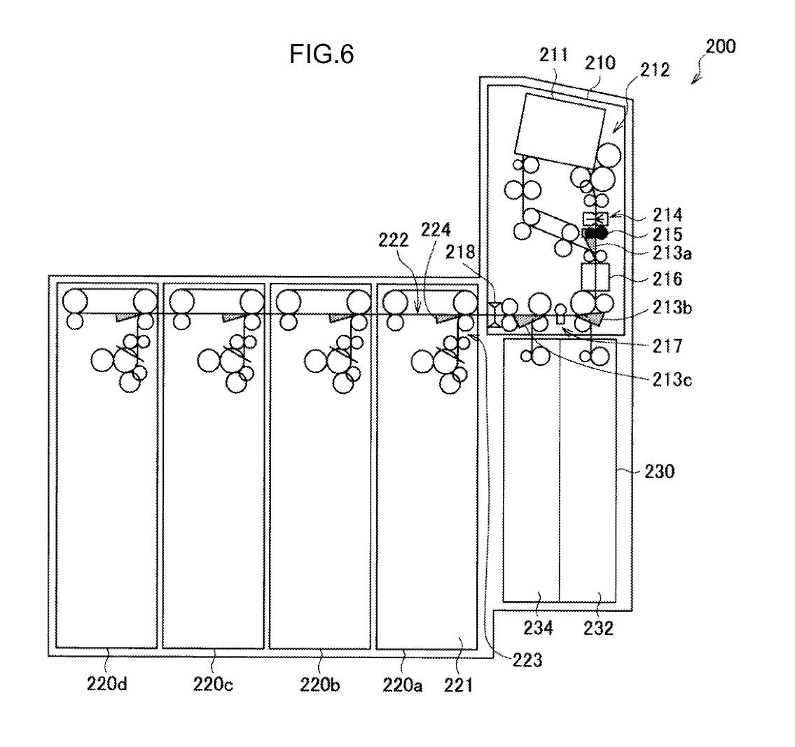

The schematic structure of a bill depositing and dispensing device relating to a second exemplary embodiment of the present invention is described next with reference to FIG. 6. Note that FIG. 6 is a schematic structural drawing showing the structure of a bill depositing and dispensing device 200 relating to the present exemplary embodiment. As compared with the bill depositing and dispensing device 100 relating to the first exemplary embodiment, the bill depositing and dispensing device 200 relating to the present exemplary embodiment differs with regard to the point that the thickness sensors 124 that are provided at the respective storage cassettes 120a through 120d are collected together into a single sensor within a customer interface unit 210. Hereinafter, structures and functions that are the same as those of the bill depositing and dispensing device 100 relating to the first exemplary embodiment are described briefly, and priority is given to explanation of the points that differ from the bill depositing and dispensing device 100 relating to the first exemplary embodiment.

As shown in FIG. 6, the bill depositing and dispensing device 200 relating to the present exemplary embodiment is formed from the customer interface unit 210, storage cassettes 220 (220a through 220d), and a reject take-in unit 230.

The customer interface unit 210 is a unit that carries out receiving of and transfer of bills from and to a user. In the same way as the customer interface unit 110 relating to the first exemplary embodiment, the customer interface unit 210 has a customer interface opening 211 having a draw-out mechanism that draws-out deposited bills and an accumulating mechanism that accumulates dispensed bills, and a conveying path 212 that connects the customer interface opening 211 with the storage cassettes 220 and the reject take-in unit 230. Further, switching mechanisms 213a, 213b, 213c, and a transmission-type image sensor 214, a thickness sensor 215, a reflection-type image sensor 216 and a magnetic sensor 217, that are for identifying the denomination, the legitimate/counterfeit nature, the thickness and the like of a bill, are provided on the conveying path 212 of the customer interface unit 210.

Further, the customer interface unit 210 relating to the present exemplary embodiment has, between the adjacent storage cassette 220a and the switching mechanism 213c, a thickness sensor 218 that identifies the thickness of a bill dispensed from the storage cassettes 220. Because the thicknesses of bills that are drawn-out from the respective storage cassettes 220a through 220d can be identified by this thickness sensor 218, there is no need to provide thickness sensors respectively at the respective storage cassettes 220a through 220d. Due thereto, the number of parts of the device can be reduced, the structure can be simplified even more, and an inexpensive device can be realized.

The storage cassette 220 has a storage portion 221 that stores bills, a first conveying path 222 that makes possible the transfer of bills in both directions between the customer interface unit 210 and the storage cassettes 220 positioned before and after, and a second conveying path 223 having a draw-out mechanism that draws-out a bill from the storage portion 221 and an accumulating mechanism that accumulates bills into the storage portion 221. Further, the storage cassette 220 has a switching mechanism 224 for switching the destination of conveying of a bill. In the bill depositing and dispensing device 200 relating to the present exemplary embodiment as well, the four storage cassettes 220a through 220d are provided in a state of being lined-up in the horizontal direction, and the respective storage cassettes 220a through 220d are structured the same. Note that the number of the storage cassettes 220 that are provided at the bill depositing and dispensing device 200 is not limited to this example, and, for example, the storage cassettes 220 can be provided in accordance with the number of types of bills. Further, at at least one of the storage cassettes 220a through 220d, the switching mechanism 224 of that storage cassette 220 may be a switching mechanism that can switch the traveling of a bill in three directions.

The reject take-in unit 230 has a rejected medium depository 232 that stores bills that are identified as being fed in an overlapping manner due to an abnormality in the drawing-out at the time of the dispensing processing, and a left-behind medium depository 234 that stores bills that users have forgotten to take. The reject take-in unit 230 can be structured similarly to the reject take-in unit 130 relating to the first exemplary embodiment.

[Operation of Bill Depositing and Dispensing Device]

The bill depositing and dispensing device 200 relating to the present exemplary embodiment as well can carry out depositing processing of a bill, deposit return processing, dispensing processing, and taking-in processing of a dispensed bill that has been left behind, in the same way as the bill depositing and dispensing device 100 relating to the first exemplary embodiment shown in FIG. 2 through FIG. 5. Therefore, detailed description of the above-described processings is omitted here.

The bill depositing and dispensing device 200 relating to the present exemplary embodiment as well can carry out processings required of the device by few structural units, in the same way as the bill depositing and dispensing device 100 relating to the first exemplary embodiment. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized. Further, by reducing the number of units, there are fewer places at which the work of opening/closing a unit and the work of clearing-up a jam are needed, and the ease of operation also can be improved. Moreover, by shortening the conveying path length, sounds generated from the device also can be reduced.

Further, by arranging the respective units such that no unit exists above the storage cassettes 220, not only does the ease of the operation of loading/removing the storage cassettes 220 improve, but also, there is no need to separately pull out units at an upper portion and units at a lower portion, and the need to respectively provide rail members and lock mechanism members also is eliminated. Moreover, in a case in which a substrate that controls the operation of units at an upper portion and a substrate that controls the operation of units at a lower portion are provided separately, the substrates can be made integral. Therefore, electronic parts having redundant functions, cords that connect the substrates, and cord guide members can be eliminated, and thus, the structure of the device can be simplified, and an inexpensive device can be realized. There is also the advantage that, when adding storage cassettes in accordance with the demands of the user, such a situation can be handled by making slight changes.

Moreover, at the bill depositing and dispensing device 200 relating to the present exemplary embodiment, the thickness sensor that identifies the thicknesses of bills dispensed from the storage cassettes 220 is structured to be collected together as a single sensor at the customer interface unit 210. Therefore, the number of parts of the device can be reduced even more, and a simplified, inexpensive device can be realized.

### 3. Third Exemplary Embodiment

### [Structure of Bill Depositing and Dispensing Device]

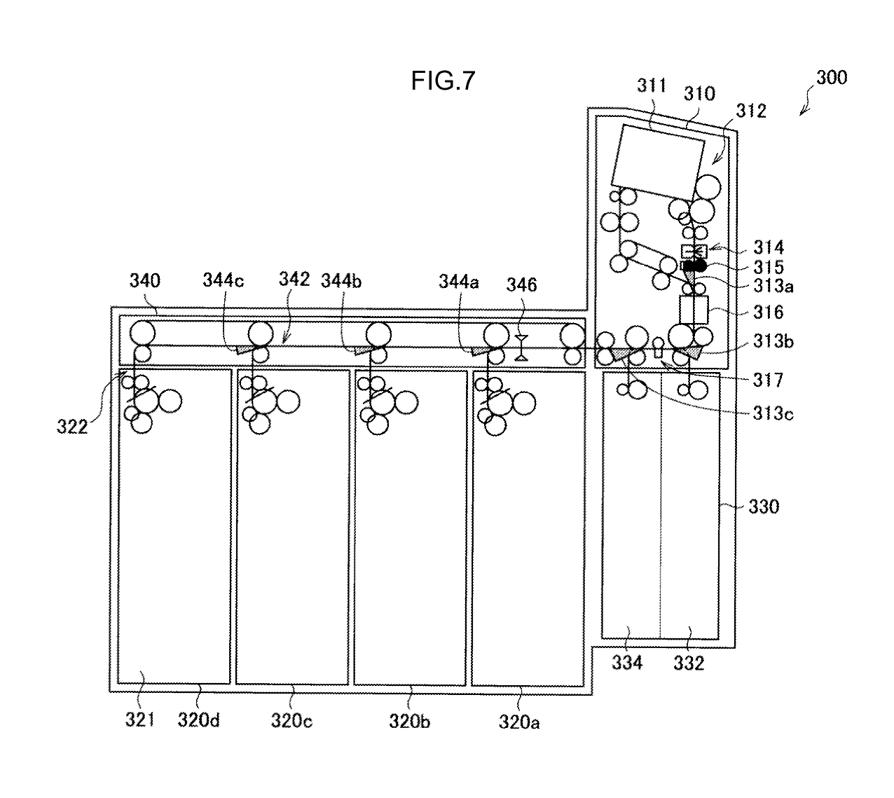

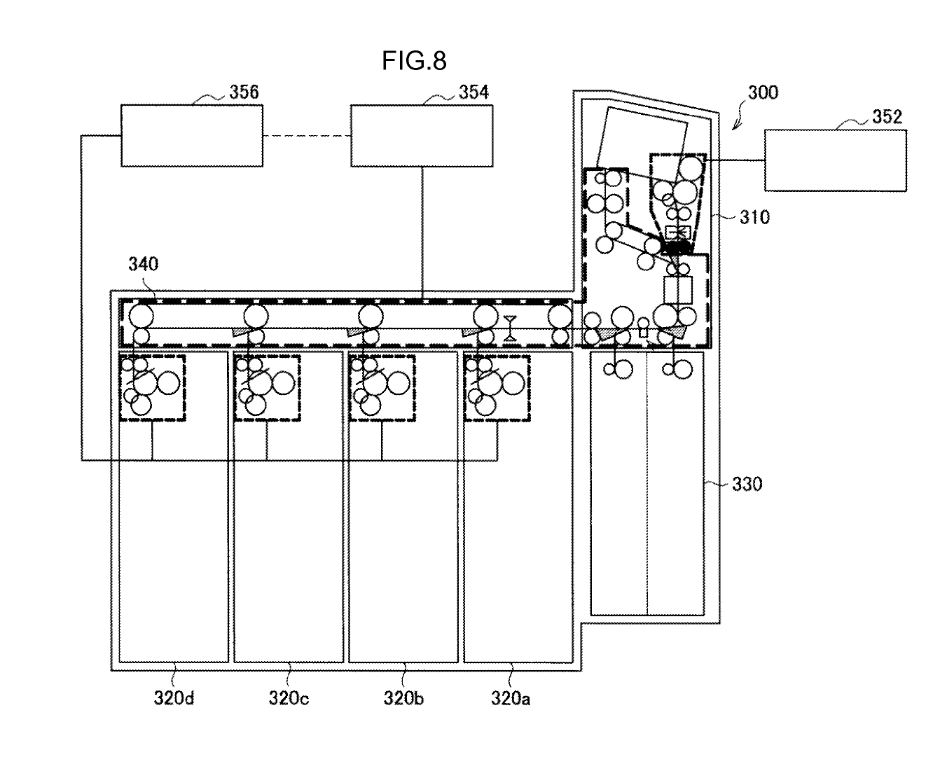

The schematic structure of a bill depositing and dispensing device relating to a third exemplary embodiment of the present invention is described next with reference to FIG. 7 and FIG. 8. Note that FIG. 7 is a schematic structural drawing showing the structure of a bill depositing and dispensing device 300 relating to the present exemplary embodiment. FIG. 8 is an explanatory drawing showing motor driving ranges of the bill depositing and dispensing device 300 relating to the third exemplary embodiment. As compared with the bill depositing and dispensing device 100 relating to the first exemplary embodiment, the bill depositing and dispensing device 300 relating to the present exemplary embodiment differs with regard to the point that the first conveying paths 122, the thickness sensors 124, and the switching mechanisms 125 that are provided at the respective storage cassettes 120a through 120d are collected into a unit that is separate from the storage cassettes 120. Hereinafter, structures and functions that are the same as those of the bill depositing and dispensing device 100 relating to the first exemplary embodiment are described briefly, and priority is given to explanation of the points that differ from the bill depositing and dispensing device 100 relating to the first exemplary embodiment.

As shown in FIG. 7, the bill depositing and dispensing device 300 relating to the present exemplary embodiment is formed from a customer interface unit 310, storage cassettes 320 (320a through 320d), a reject take-in unit 330, and a conveying unit 340.

The customer interface unit 310 is a unit that carries out receiving of and transfer of bills from and to a user. In the same way as the customer interface unit 110 relating to the first exemplary embodiment, the customer interface unit 310 has a customer interface opening 311 having a draw-out mechanism that draws-out deposited bills and an accumulating mechanism that accumulates dispensed bills, and a conveying path 312 that connects the customer interface opening 311 with the conveying unit 340 and the reject take-in unit 330. Further, switching mechanisms 313a, 313b, 313c, and a transmission-type image sensor 314, a thickness sensor 315, a reflection-type image sensor 316 and a magnetic sensor 317, that are for identifying the denomination, the legitimate/counterfeit nature, the thickness and the like of a bill, are provided on the conveying path 312 of the customer interface unit 310.

The storage cassette 320 has a storage portion 321 that stores bills, and a conveying path 322 having a draw-out mechanism that draws-out a bill from the storage portion 321 and an accumulating mechanism that accumulates bills into the storage portion 321. In the bill depositing and dispensing device 300 relating to the present exemplary embodiment as well, the four storage cassettes 320a through 320d are provided in a state of being lined-up in the horizontal direction, and the respective storage cassettes 320a through 320d are structured the same. Note that the number of the storage cassettes 320 that are provided at the bill depositing and dispensing device 300 is not limited to this example, and, for example, the storage cassettes 320 can be provided in accordance with the number of types of bills.

The reject take-in unit 330 has a rejected medium depository 332 that stores bills that are identified as being fed in an overlapping manner due to an abnormality in the drawing-out at the time of the dispensing processing, and a left-behind medium depository 334 that stores bills that users have forgotten to take. The reject take-in unit 330 can be structured similarly to the reject take-in unit 130 relating to the first exemplary embodiment.

The conveying unit 340 has a mechanism that connects the customer interface unit 310 and the respective storage cassettes 320a through 320d, and that conveys bills in both directions. Concretely, as shown in FIG. 7, the conveying unit 340 has a conveying path 342, switching mechanisms 344a, 344b, 344c, and a thickness sensor 346. The conveying path 342 draws bills into the respective storage cassettes 320, and conveys bills, that have been drawn-out from the respective storage cassettes 320, to the customer interface unit 310. The switching mechanisms 344a, 344b, 344c selectively switch the conveying path 342 to the respective storage cassettes 320a through 320d. Note that at least one of the switching mechanisms 344a, 344b, 344c may be a switching mechanism that can switch the traveling of a bill in three directions.

Here, in the bill depositing and dispensing device 100 relating to the first exemplary embodiment, in order to draw-out a bill from the customer interface unit 110 and convey the bill along the conveying path and feed the bill into the storage cassette 120 at the time of depositing, conveying rollers are rotated by a conveying motor (not shown in the drawings). At this time, if a bill is identified as a counterfeit bill or a damaged bill by the transmission-type image sensor 114, the thickness sensor 115, the reflection-type image sensor 116 and the magnetic sensor 117 that are for identifying the denomination, legitimate/counterfeit nature, thickness and the like of bills, processing is carried out so as to reversely rotate the conveying motor and return the bill to the customer interface opening 111.

When the draw-out rollers of the customer interface unit 110 are rotated by the aforementioned conveying motor, the mechanisms and processings for separating, among the bills that are returned to the customer interface opening 111 after having been drawn-out from the customer interface opening 111, the bill that is accumulated at the leading end of the bills that remain without being drawn-out from the customer interface opening 111 interior (the bill that exists between the bill draw-out opening of the customer interface opening 111 and the switching mechanism 113a and that follows after the bill for which deposit was rejected and that is conveyed to the customer interface opening 111 in the direction opposite the draw-out direction), and the bill that is accumulated at the final end of the bills that remain within the customer interface opening 111 without being drawn-out (the bill for which deposit was rejected and that is drawn-in from the bill draw-in opening of the customer interface opening 111) are complex. On the other hand, when the motors that rotate the conveying rollers and the draw-out rollers are installed separately, the customer interface unit becomes expensive.

Further, at the time of bill dispensing, a bill is drawn-out from the storage cassette 120, and the conveying rollers are rotated by the conveying motor (not shown in the drawings) in order to transfer the bill to the customer interface unit 110 or, via the first conveying path 122, to the storage cassette 120 that is disposed adjacent at the customer interface unit 110 side. At this time, when the draw-out rollers of the storage cassette 120 also are rotated by the same motor as the motor that rotates the conveying rollers, there is the concern that a bill that is not the designated denomination may be drawn-out from the storage cassette 120, and the mechanism and processing for preventing this are complex. On the other hand, when the motors that rotate the conveying rollers and the draw-out rollers are installed separately, the storage cassettes 120 become expensive.

Thus, as shown in FIG. 8, the bill depositing and dispensing device 300 relating to the present exemplary embodiment is provided with a customer interface draw-out motor 352, a conveying motor 354, and a cassette draw-out motor 356, such that the ranges of driving by the respective motors are divided. The customer interface draw-out motor 352 drives the conveying rollers of the conveying path 312 of the draw-out portion of the customer interface unit 310. Further, the conveying motor 354 drives the conveying rollers of the conveying path 312 at the return portion of the customer interface unit 310, and the conveying rollers of the conveying path 342 of the conveying unit 340. The conveying rollers of the customer interface unit 310 and the conveying rollers of the conveying unit 340 are connected by a joint mechanism (not shown in the drawings). Further, the cassette draw-out motor 356 drives the conveying rollers of the conveying paths 322 of the respective storage cassettes 320. By driving the conveying rollers of the respective conveying paths in this way, the respective functions can be implemented by a simple structure without the number of motors increasing greatly.

[Operation of Bill Depositing and Dispensing Device]

This bill depositing and dispensing device 300 as well can carry out depositing processing of a bill, deposit return processing, dispensing processing, and taking-in processing of a dispensed bill that has been left behind, in the same way as the bill depositing and dispensing device 100 relating to the first exemplary embodiment shown in FIG. 2 through FIG. 5. Therefore, detailed description of the above-described processings is omitted here.

The bill depositing and dispensing device 300 relating to the present exemplary embodiment as well can carry out processings required of the device by few structural units, in the same way as the bill depositing and dispensing device 100 relating to the first exemplary embodiment. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized.

In the bill depositing and dispensing device 300 relating to the present exemplary embodiment, not only are effects that are similar to those of the bill depositing and dispensing devices 100, 200 of the first exemplary embodiment and the second exemplary embodiment obtained, but also, the following effects are obtained by adding the conveying unit 340 and at least one conveying motor. Namely, at the time of depositing, when carrying out the processing of returning, to the customer interface opening 311, a bill that is identified as a counterfeit bill or a damaged bill, the mechanism and the processing for separating the bill, that is accumulated at the leading end of the bills that remain without being drawn-out from the customer interface opening 311 interior, and the bill, that is accumulated at the final end of the bills that remain within the customer interface opening 311 without being drawn-out, can be made to be easy.

Further, at the time of dispensing, when a bill that has been drawn-out from the storage cassette 320 is transferred via the conveying unit 340 to the customer interface unit 310, the conveying unit 340 and a portion of the customer interface unit 310 are driven by the conveying motor 354, and the cassette draw-out motor 356, that drives the conveying rollers of the conveying paths 322 of the storage cassettes 320 that are not designated, can be stopped. Accordingly, a bill of a denomination that is not designated is not drawn-out from the storage cassette 320.

Further, by providing the conveying unit 340 separately, the switching mechanisms 344a, 344b, 344c and the conveying path 342 are cut-out from the storage cassettes 320. Due thereto, the storage cassettes 320 can be made to be lighter-weight, and moving of the storage cassettes 320 can be facilitated.

### 4. Fourth Exemplary Embodiment

### [Structure of Bill Depositing and Dispensing Device]

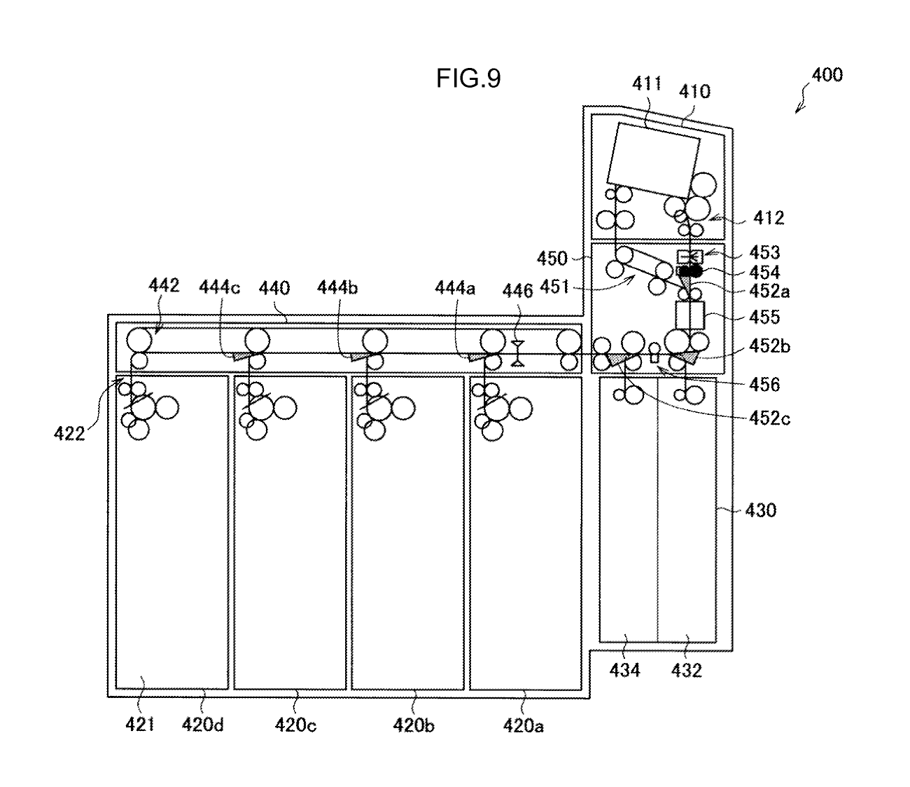

The schematic structure of a bill depositing and dispensing device relating to a fourth exemplary embodiment of the present invention is described next with reference to FIG. 9. Note that FIG. 9 is a schematic structural drawing showing the structure of a bill depositing and dispensing device 400 relating to the present exemplary embodiment. As compared with the bill depositing and dispensing device 300 relating to the third exemplary embodiment, the bill depositing and dispensing device 400 relating to the present exemplary embodiment differs with regard to the point that the functions of the customer interface unit are divided in two. Hereinafter, structures and functions that are the same as those of the bill depositing and dispensing device 300 relating to the third exemplary embodiment are described briefly, and priority is given to explanation of the points that differ from the bill depositing and dispensing device 300 relating to the third exemplary embodiment.

As shown in FIG. 9, the bill depositing and dispensing device 400 relating to the present exemplary embodiment is formed from a customer interface unit 410, storage cassettes 420 (420a through 420d), a reject take-in unit 430, a first conveying unit 440, and a second conveying unit 450. Because the storage cassettes 420, the reject take-in unit 430 and the first conveying unit 440 have the same structures and functions as the storage cassettes 320, the reject take-in unit 330 and the conveying unit 340, description thereof is omitted here.

The customer interface unit 410 and the second conveying unit 450 relating to the present exemplary embodiment correspond to the customer interface unit 310 relating to the third exemplary embodiment. Because the customer interface unit 310 of the third exemplary embodiment is a large unit, in the present exemplary embodiment, the customer interface unit 310 is separated into two units in order to improve the maintenance workability when there is a problem with any of the various sensors or the like and unit replacement work by a maintenance worker is carried out. Due thereto, when carrying out work on a unit-by-unit basis such as the work of adjusting any of the various sensors, the unit that is used in the adjustment is small, and therefore, the adjustment workability can be improved.

Concretely, the customer interface unit 410 is a unit that carries out receiving of and transfer of bills from and to a user, and has a customer interface opening 411 having a draw-out mechanism that draws-out deposited bills and an accumulating mechanism that accumulates dispensed bills, and a conveying path 412 that connects the customer interface opening 411 and the second conveying unit 450. Further, the second conveying unit 450 has a conveying path 451 that conveys bills, and has, on the conveying path 451, switching mechanisms 452a, 452b, 452c, and a transmission-type image sensor 453, a thickness sensor 454, a reflection-type image sensor 455 and a magnetic sensor 456, that are for identifying the denomination, the legitimate/counterfeit nature, the thickness and the like of a bill. At this time, in order to transmit the drive of the accumulating rollers of the customer interface opening 411 of the customer interface unit 410, a joint mechanism (not shown in the drawings) is added at the portion where the conveying path, that is connected to the bill draw-in opening of the customer interface opening 411, is divided between the customer interface unit 410 and the conveying unit 450.

[Operation of Bill Depositing and Dispensing Device]

This bill depositing and dispensing device 400 as well can carry out depositing processing of a bill, deposit return processing, dispensing processing, and taking-in processing of a dispensed bill that has been left behind, in the same way as the bill depositing and dispensing device 100 relating to the first exemplary embodiment shown in FIG. 2 through FIG. 5. Therefore, detailed description of the above-described processings is omitted here.

The bill depositing and dispensing device 400 relating to the present exemplary embodiment as well can carry out processings required of the device by few structural units, in the same way as the bill depositing and dispensing device 100 relating to the first exemplary embodiment. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized.

Further, in the bill depositing and dispensing device 400 relating to the present exemplary embodiment, the large customer interface unit 310, such as in the third exemplary embodiment for example, is separated into the customer interface unit 410 and the second conveying unit 450, and the scale of the units is reduced. Due thereto, even when there is a problem with any of the various sensors or the like and unit replacement work by a maintenance worker is carried out, unit replacement can be carried out easily, and the maintenance workability can be improved. Further, also when adjustment work of a unit is carried out, the work for adjusting the unit can be carried out in small units, and therefore, the adjustment workability also can be improved.

### 5. Fifth Exemplary Embodiment

### [Structure of Bill Depositing and Dispensing Device]

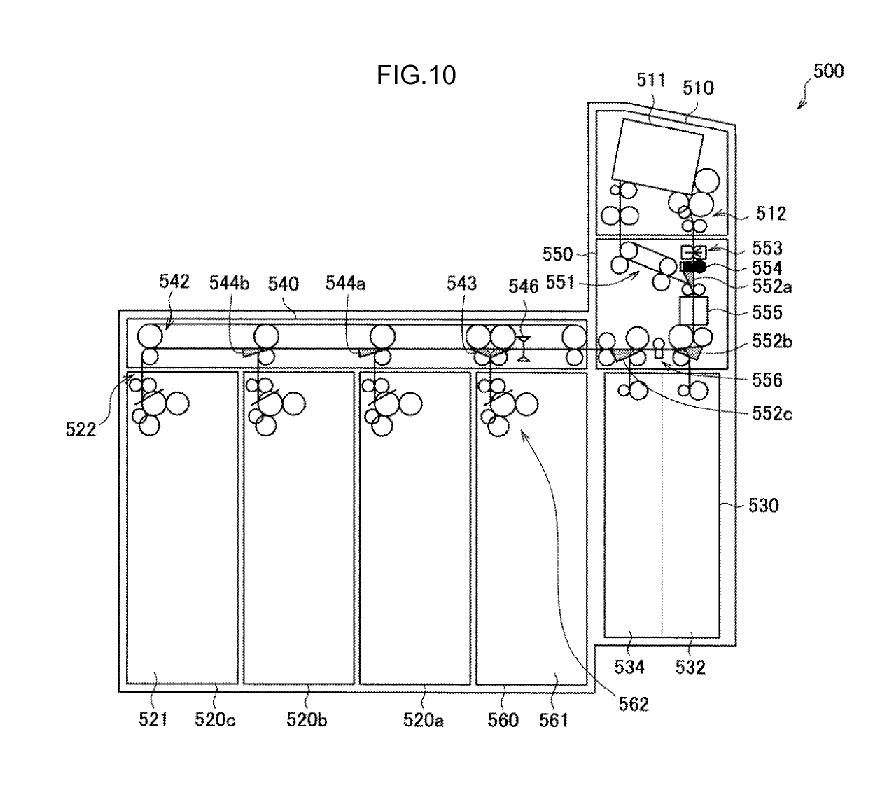

The schematic structure of a bill depositing and dispensing device relating to a fifth exemplary embodiment of the present invention is described next with reference to FIG. 10. Note that FIG. 10 is a schematic structural drawing showing the structure of a bill depositing and dispensing device 500 relating to the present exemplary embodiment. As compared with the bill depositing and dispensing devices relating to the first through fourth exemplary embodiments, the bill depositing and dispensing device 500 relating to the present exemplary embodiment differs with regard to the points that a temporary holding section unit 560 is provided, and at least one of the switching mechanisms within the storage cassettes or the conveying unit can switch the traveling of a bill in three directions. Hereinafter, structures and functions that are the same as those of the bill depositing and dispensing device 400 relating to the fourth exemplary embodiment are described briefly, and priority is given to explanation of the points that differ from the bill depositing and dispensing device 400 relating to the fourth exemplary embodiment.

As shown in FIG. 10, the bill depositing and dispensing device 500 relating to the present exemplary embodiment is formed from a customer interface unit 510, storage cassettes 520 (520a through 520c), a reject take-in unit 530, a first conveying unit 540, a second conveying unit 550, and the temporary holding section unit 560. Because the customer interface unit 510, the reject take-in unit 530 and the second conveying unit 550 have the same structure and functions as the customer interface unit 410, the reject take-in unit 430 and the second conveying unit 450, description thereof is omitted here. Further, there is one fewer of the storage cassettes 520 than the storage cassettes 420 of the fourth exemplary embodiment. However, because the respective storage cassettes 520a through 520c have the same structures and functions as the storage cassettes 420a through 420d, description thereof also is omitted.

The bill depositing and dispensing device 500 relating to the present exemplary embodiment has the temporary holding section unit 560 in order to make it easy to separate a bill that is to be returned to the user and a bill that is to remain within the device and is not to be returned to the user, in a case in which trouble such as a jam or the like arises while the user is in the midst of a transaction and a maintenance worker must remove bills that remain within the device. As shown in FIG. 10, the temporary holding section unit 560 can be structured the same as the storage cassettes 420, and has a storage portion 561 and a conveying path 562. Further, by lining-up the temporary holding section unit 560 in the horizontal direction together with the storage cassettes 420 and setting the temporary holding section unit 560 at the side nearest to the customer interface unit 510, the temporary holding section unit 560 can easily be made to function as a unit that temporarily stores bills.

Further, by providing the temporary holding section unit 560, among the switching mechanisms of the first conveying unit 540, only a switching mechanism 543 that conveys bills to the temporary holding section unit 560 is a three-way switching mechanism that can move bills in the three directions of the second conveying unit 550, the temporary holding section unit 560, and the storage cassettes 520. It suffices for other switching mechanisms 544a and 544b to be able to switch in at least two directions. The other structures of the first conveying unit 540 are the same as the structures of the first conveying unit 440 relating to the fourth exemplary embodiment.

[Operation of Bill Depositing and Dispensing Device]

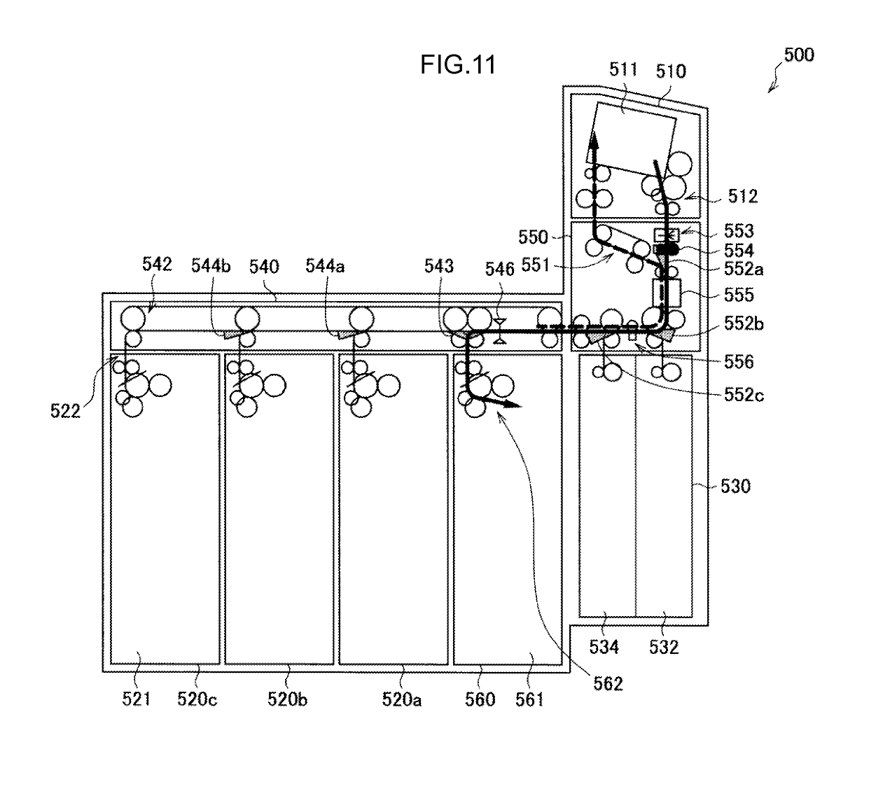

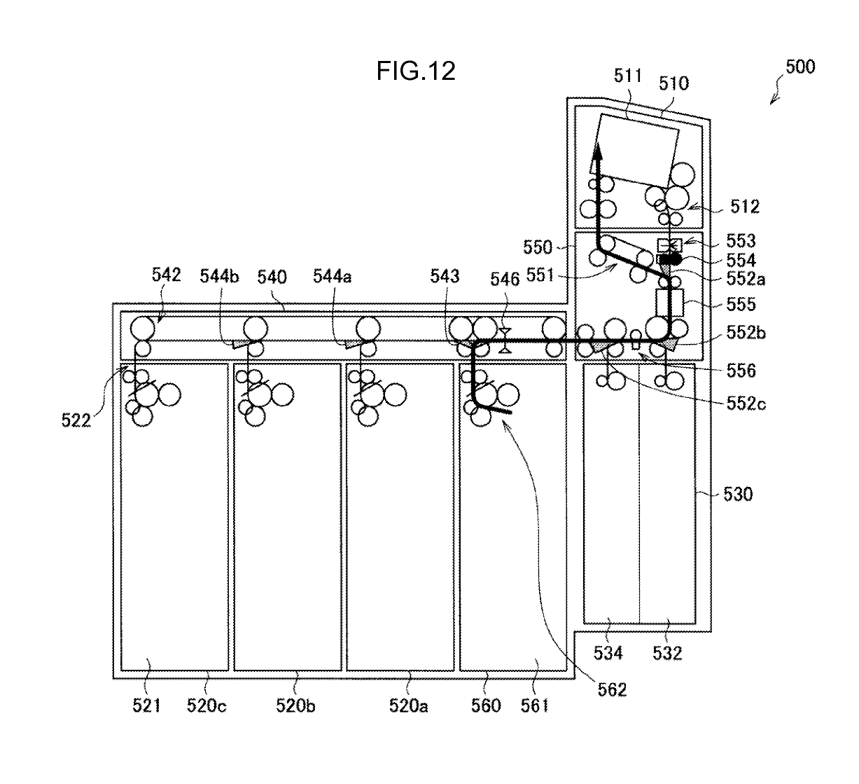

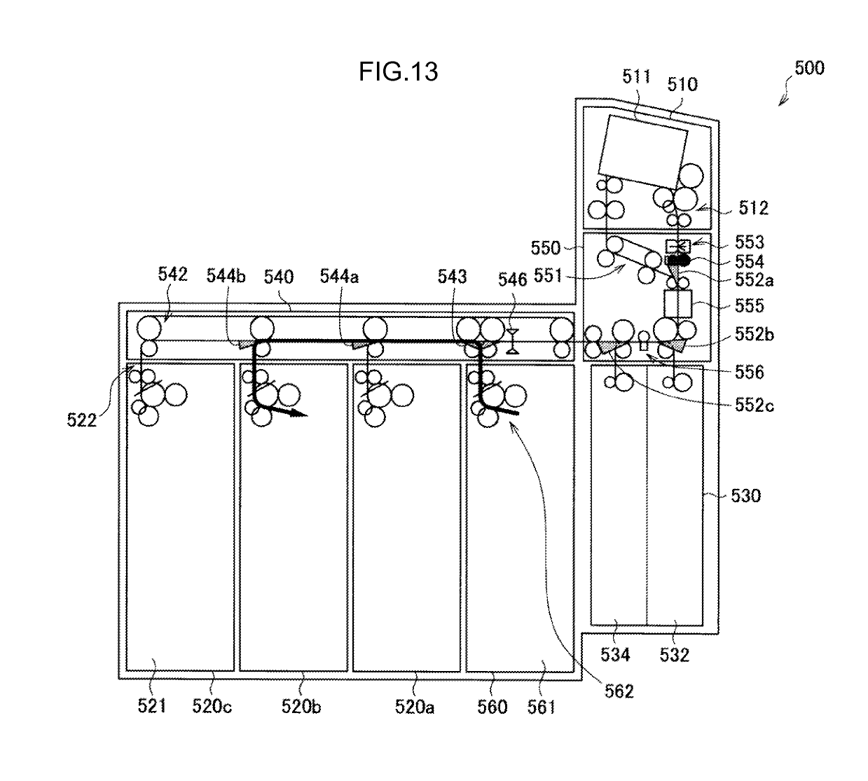

Next, the operation of the bill depositing and dispensing device 500 relating to the present exemplary embodiment is described on the basis of FIG. 11 through FIG. 13. Note that FIG. 11 is an explanatory drawing showing the flow of a bill at the time of depositing processing of the bill depositing and dispensing device 500 relating to the present exemplary embodiment. FIG. 12 is an explanatory drawing showing the flow of a bill at the time of deposit return processing of the bill depositing and dispensing device 500 relating to the present exemplary embodiment. FIG. 13 is an explanatory drawing showing the flow of a bill at the time of storing processing of the bill depositing and dispensing device 500 relating to the present exemplary embodiment.

(1) At the Time of Depositing Processing

First, the operation of the bill depositing and dispensing device 500 at the time of depositing processing is described on the basis of FIG. 11. A bill that is deposited from the customer interface opening 511 of the customer interface unit 510 is conveyed along the path shown by the solid line arrow in FIG. 11. Namely, at the bill depositing and dispensing device 500, a bill that has been inserted into the customer interface opening 511 is, via the second conveying unit 550, drawn-into the temporary holding section unit 560 by the switching mechanism 543 of the first conveying unit 540. At this time, the bill is discriminated by the transmission-type image sensor 553, the thickness sensor 554, the reflection-type image sensor 555 and the magnetic sensor 556 that are provided on the conveying path of the second conveying unit 550. The bill depositing and dispensing device 500 draws only bills, at which no abnormalities are detected as a result of the discrimination, into the temporary holding section unit 560 by the path of the solid line arrow shown in FIG. 11.

Note that, when there is a bill that is identified as a counterfeit bill or a damaged bill due to the results of the discrimination, the bill depositing and dispensing device 500 stops the motor (not shown in the drawings), and switches the switching mechanism 552a, and thereafter, drives the motor in the opposite rotational direction. Due thereto, the bill, that is identified as a counterfeit bill or a damaged bill, is conveyed to the customer interface opening 511 on the path shown by the dashed line arrow of FIG. 11. That bill that is returned to the customer interface opening 511 is accumulated at the final end of the bills that remain within the customer interface opening 511 without being drawn-out.

Thereafter, by again driving the motor in the direction of drawing-out bills, the depositing processing is restarted, and the bills that remain in the customer interface opening 511 without being drawn-out, and the bill that is identified as a counterfeit bill or a damaged bill, are again drawn-out from the customer interface opening 511. Then, in a case in which there is a bill, that is identified as a counterfeit bill or a damaged bill even when the depositing processing is carried out a predetermined number of times and that is returned to the customer interface opening 511 without being conveyed to the storage cassettes 520, the bill depositing and dispensing device 500 opens the shutter (not shown in the drawings) of the customer interface opening 511 and returns that bill to the user. At this time, by providing the path shown by the dashed line arrow in FIG. 11, a bill that is identified as a counterfeit bill or a damaged bill can be accumulated at the final end of the bills that remain within the customer interface opening 511 without being drawn-out. Accordingly, it is possible to return to the user only the bill that is identified as a counterfeit bill or a damaged bill.

(2) At the time of Deposit Return Processing

Next, operation of the bill depositing and dispensing device 500 at the time of deposit return processing is described on the basis of FIG. 12. When a bill, that a user has inserted into the customer interface opening 511 is conveyed along the path of the solid line arrow in FIG. 11 and is stored in the temporary holding section unit 560 and, thereafter, the depositing processing is cancelled, the bill depositing and dispensing device 500 draws the deposited bill out from the temporary holding section unit 560, and conveys the bill along the path of the solid line arrow in FIG. 12 and draws the bill into the customer interface opening 511. Then, the bill depositing and dispensing device 500 opens the shutter (not shown in the drawings) of the customer interface opening 511 and returns that bill to the user.

(3) At the time of Storing Processing

Operation of the bill depositing and dispensing device 500 at the time of storing processing is described on the basis of FIG. 13. When the bill depositing and dispensing device 500 receives a deposit confirm instruction from a user and confirms that a transaction has been established, the switching mechanism 543 of the first conveying unit 540 is switched such that the bill is conveyed from the temporary holding section unit 560 to the storage cassette 520. Then, the bill, that is drawn-out from the temporary holding section unit 560, is conveyed along the path shown by the solid line arrow of FIG. 13, and, on the basis of the results of the identification by the transmission-type image sensor 553, the thickness sensor 554, the reflection-type image sensor 555 and the magnetic sensor 556 at the time of the depositing processing, the bill is drawn-into the corresponding storage cassette 520.

Note that the operations of the dispensing processing and the processing of taking-in a dispensed bill that has been left behind of the bill depositing and dispensing device 500 are similar to the operations shown in FIG. 4 and FIG. 5, and therefore, description thereof is omitted here.

The structure and operation of the bill depositing and dispensing device 500 relating to the present exemplary embodiment are described above. The bill depositing and dispensing device 500 relating to the present exemplary embodiment can carry out processings required of the device by few structural units, in the same way as the bill depositing and dispensing device 100 relating to the first exemplary embodiment. In the bill depositing and dispensing device 500, although the temporary holding section unit 560 is added, it has the same structure as the storage cassettes 520 and can be treated as equivalent to the storage cassettes 520. Therefore, the number of units does not increase as compared with the bill depositing and dispensing device 400 relating to the fourth exemplary embodiment. By reducing the number of units that structure the device, the conveying path length of bills is shortened, and the number of parts such as conveying motors, conveying rollers, drive transmission parts, conveying guides, travel sensors and the like also can be reduced. Therefore, the structure of the device can be simplified, and an inexpensive device can be realized.

Further, in the bill depositing and dispensing device 500 relating to the present exemplary embodiment, in the same way as the bill depositing and dispensing device 400 relating to the fourth exemplary embodiment, the maintenance workability can be improved, and the adjustment workability also can be improved. Moreover, by providing the temporary holding section unit 560, when trouble such as a jam or the like arises while the user is in the midst of a transaction and a maintenance worker must remove bills that remain within the device, the processing of separating a bill that is to be returned to the user and a bill that is to remain within the device and is not to be returned to the user, can be made to be easy. Still further, by making the temporary holding section unit 560 have the same structure as the storage cassettes 520 as described above, it is possible to select, in accordance with the requirements of the user, whether the temporary holding section unit 560 is to be used as a storage cassette or is to be used as a temporary holding section unit, and the settings of the device can be changed flexibly.

Exemplary embodiments of the present invention are described in detail above with reference to the appended drawings, but the present invention is not limited to these examples. It is clear that a person having ordinary knowledge in the technical field to which the present invention belongs can conceive of various types of changed examples or modified examples within the range of the technical concept recited in the claims, and such examples as well are to be understood as falling within the technical scope of the present invention as a matter of course.

For example, although the media that are handled in the above-described exemplary embodiments are bills, the present invention is not limited to this example. For example, the bill depositing and dispensing devices relating to the above exemplary embodiments can be used for sheet-shaped media, and, other than bills, can be applied as well to, for example, bonds, securities, and the like.

What is claimed is:

1. A bill depositing and dispensing device comprising:
a customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, and a discriminating section that discriminates a bill that is conveyed on the conveying path;
at least one storage cassette that includes a storage portion that stores a bill, a first conveying path that connects to the customer interface unit or an adjacent storage cassette, a second conveying path that conveys a bill in both directions between the first conveying path and the storage portion, a switching mechanism that switches a traveling path of a bill, and a thickness sensor that identifies a thickness of a bill that is drawn-out from the storage portion; and
a reject take-in unit that stores a bill that is not held at the customer interface unit and the storage cassette.

2. The bill depositing and dispensing device of claim 1, wherein the switching mechanism of the customer interface unit comprises:
a first switching mechanism that bifurcates a drawn-out conveying path of a bill that is drawn-out from the customer interface opening and a drawn-into conveying path of a bill that is drawn-into the customer interface opening, the conveying path including the drawn-out conveying path and the drawn-into conveying path;
a second switching mechanism that switches the conveying path such that an abnormal bill, at which an abnormality is detected by the discriminating section of the customer interface unit or the thickness sensor of the storage cassette, is conveyed to a first depository of the reject take-in unit; and
a third switching mechanism that switches the conveying path such that a bill, that has been left behind at the customer interface opening, is conveyed to a second depository of the reject take-in unit.

3. The bill depositing and dispensing device of claim 1, wherein the discriminating section of the customer interface unit is structured by a plurality of sensors for judging a legitimate/counterfeit nature of a bill and for identifying overlapped-feeding of bills that are conveyed on the conveying path, and
the plurality of sensors that structure the discriminating section are disposed such that, the longer the time required for data processing by a sensor, the nearer to the customer interface opening the sensor is located.

4. The bill depositing and dispensing device of claim 2, wherein the discriminating section of the customer interface unit is structured by a plurality of sensors for judging a legitimate/counterfeit nature of a bill and for identifying overlapped-feeding of bills that are conveyed on the conveying path, and
the plurality of sensors that structure the discriminating section are disposed such that, the longer the time required for data processing by a sensor, the nearer to the customer interface opening the sensor is located.

5. The bill depositing and dispensing device of claim 1, wherein the customer interface unit and the storage cassette are disposed so as to be adjacent to one another in a horizontal direction.

6. The bill depositing and dispensing device of claim 2, wherein the customer interface unit and the storage cassette are disposed so as to be adjacent to one another in a horizontal direction.

7. A bill depositing and dispensing device comprising:
a customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, a discriminating section that discriminates a bill that is conveyed on the conveying path, and a thickness sensor that identifies a thickness of a bill that is drawn-out to the customer interface opening;
at least one storage cassette that includes a storage portion that stores a bill, a first conveying path that connects to the customer interface unit or an adjacent storage cassette, a second conveying path that conveys a bill in both directions between the first conveying path and the storage portion, and a switching mechanism that switches a traveling path of a bill; and
a reject take-in unit that stores a bill that is not held at the customer interface unit and the storage cassette.

8. The bill depositing and dispensing device of claim 1, wherein
the bill depositing and dispensing device includes a plurality of storage cassettes, and
at at least one of the storage cassettes, the switching mechanism thereof is a switching mechanism that can switch traveling of a bill in three directions.

9. The bill depositing and dispensing device of claim 7, wherein
the bill depositing and dispensing device includes a plurality of storage cassettes, and
at at least one of the storage cassettes, the switching mechanism thereof is a switching mechanism that can switch traveling of a bill in three directions.

10. A bill depositing and dispensing device comprising:
a customer interface unit that includes a customer interface opening for carrying out a transaction of a bill with a user, a conveying path that connects the customer interface opening and a storage destination of a bill, a switching mechanism that switches a traveling path of a bill in accordance with a storage destination of a bill that is conveyed on the conveying path, and a discriminating section that discriminates a bill that is conveyed on the conveying path;
at least one storage cassette that includes a storage portion that stores a bill, and a storage cassette conveying path that conveys a bill in both directions to and from the storage portion;
a conveying unit that includes a conveying unit conveying path that connects between the customer interface unit and the storage cassette, a switching mechanism that switches a traveling path of a bill in accordance with a storage destination of the bill that is conveyed on the conveying unit conveying path, and a thickness sensor that identifies a thickness of a bill that is drawn-out from the storage cassette; and
a reject take-in unit that stores a bill that is not held at the customer interface unit and the storage cassette.

11. The bill depositing and dispensing device of claim 10, wherein the conveying unit conveying path of the conveying unit and a drawn-into conveying path of a bill, that is drawn-into the customer interface opening, of the conveying path of the customer interface unit are driven by a same driving device.

12. A bill depositing and dispensing device comprising:
a customer interface unit that includes a customer interface opening for carrying out a transaction of a bill with a user, and a conveying path that connects an adjacent unit and the customer interface opening;
a discriminating/conveying unit as the adjacent unit, which includes a discriminating/conveying unit conveying path that connects the customer interface unit and a storage destination of a bill, a switching mechanism that switches a traveling path of a bill in accordance with a storage destination of a bill that is conveyed on the discriminating/conveying unit conveying path, and a discriminating section that discriminates a bill that is conveyed on the discriminating/conveying unit conveying path;
at least one storage cassette that includes a storage portion that stores a bill, and a storage cassette conveying path that conveys a bill in both directions to and from the storage portion;
a conveying unit that includes a conveying unit conveying path that connects between the discriminating/conveying unit and the storage cassette, a switching mechanism that switches a traveling path of a bill in accordance with a storage destination of the bill that is conveyed on the conveying unit conveying path, and a thickness sensor that identifies a thickness of a bill that is drawn-out from the storage cassette; and
a reject take-in unit that stores a bill that is not held at the customer interface unit and the storage cassette.

13. The bill depositing and dispensing device of any one of claim 10, wherein:
the bill depositing and dispensing device includes a plurality of storage cassettes, and the conveying unit includes a plurality of switching mechanisms, and
at least one of the switching mechanisms of the conveying unit is a switching mechanism that can switch traveling of a bill in three directions.

14. The bill depositing and dispensing device of any one of claim 11, wherein:
the bill depositing and dispensing device includes a plurality of storage cassettes, and the conveying unit includes a plurality of switching mechanisms, and
at least one of the switching mechanisms of the conveying unit is a switching mechanism that can switch traveling of a bill in three directions.

15. The bill depositing and dispensing device of any one of claim 12, wherein:
the bill depositing and dispensing device includes a plurality of storage cassettes, and the conveying unit includes a plurality of switching mechanisms, and
at least one of the switching mechanisms of the conveying unit is a switching mechanism that can switch traveling of a bill in three directions.
